(19) United States
(12) Patent Application Publication
(10) Pub. No.: US 2007/0005798 A1
(43) Pub. Date: Jan. 4, 2007

(54) System and method for virtual radiology and patient document flow

(76) Inventors: Adrian Gropper, Watertown, MA (US); Sean Doyle, Watertown, MA (US); William L. Donner, Bronxville, NY (US); Hugh V. Cottingham, Caldwell, NJ (US); Yair Frankel, Westfield, NJ (US)

Correspondence Address: FISH & NEAVE IP GROUP;ROPES & GRAY LLP, ONE INTERNATIONAL PLACE, BOSTON, MA, 02110-2624, US

(21) Appl. No.: 11/089,592

(22) Filed: May 17, 2004

(51) Int. Cl. G06F 15/173

(52) U.S. Cl. 709/238

(57) ABSTRACT

The invention, in one embodiment, is directed to systems and methods for providing a “Virtual Radiology” service. This service, potentially, can provide any radiological digital image data to any computer at any institution. The service is “Virtual” in that the radiological digital image data accessible on a DICOM LAN and PACS of a first institution is made available to a second institution, without either institution having to open their networks to each other, establish legal or other business relationships and understandings or to become administratively involved with each other.

### FIELD OF THE INVENTION

The invention, in one embodiment, relates to the electronic distribution of radiological digital image data such as MR, CT, Ultrasound, X-ray etc and other patient medical-related information.

### BACKGROUND

Unwarranted medical care is said to be responsible for as much as 30% of U.S. health care expenses and represents many hundreds of billions of dollars each year. Unwarranted care is care that provides income to the provider without benefit the patient. Not only is unwarranted care expensive, but published research has shown that it reduces the quality of life and actually increases mortality. Although readily shown on a statistical basis, the problem—for both patients and payors—is to identify the specific instances of unwarranted care.

Medical information systems are typically sold to an institution and, not surprisingly, focus on the needs of institutions. As data management shifts from paper and film to digital protocols, sharing data outside of health care institutions—and thereby comparing health care across institutions—has become an ever larger problem for both patients and payors (including Medicare). Numerous information management standards such as IHE Integrating the Healthcare Enterprise) and mandates such as HIPAA are aimed at integrating and aggregating data between vendors of healthcare information systems. Although these standards and mandates address some of the technical impediments to integration of data across institutions, their effectiveness is limited by the inherent lack of motivation of the institutional customers and the systems vendors that serve them.

Sharing of data across institutions raises valid concerns about patient privacy and the risk of intrusion by payors into the practice of medicine. These concerns have been used by health care institutions to effectively delay implementation of meaningful data sharing technologies.

### BRIEF DESCRIPTION

The invention provides a solution to the concerns of patient privacy and payor intrusion, in one embodiment, by placing the patient and their doctor in control of the information sharing process. In various aspects of the illustrative embodiments, the systems and methods of the invention establish a central facility, which is neither a provider nor a payor, in a role of trusted intermediary under the control of the patient. The physician acts as the agent responsible for the transfer of control from the institution to the central facility. The central facility operates under the privacy and security mandates that govern protected health information while also allowing the patient to decide who will have access to their information. Though a one intent is to be patient centric, the systems and methods of the invention are also beneficial in a non-patient centric model where holders and users (e.g., of patient information) use the central facility without direct patient access.

Radiology information is particularly well suited to the innovation because medical images are very large data sets that cannot be readily transferred between institutions with more traditional patient-controlled electronic systems such as the fax machine or xerographic copier. As digital radiology information management systems (PACS) become more prevalent inside provider institutions, it becomes feasible for individual physicians (and other licensed and/or responsible health care workers) to make secure electronic copies of a patient's medical image data and to transfer control of that information to the patient in a manner equivalent to giving the patient a xerographic copy or a fax. An important benefit of the current invention is the method by which it practically and effectively allows the individual physician to use PACS technology already deployed within an institution to enable them to act as the patient's agent in this transaction. In other words, the physician, given the ability to access a PACS imaging study inside the institution for internal use can now make a copy and transfer control of that medical imaging study to the patient without an upgrade to the PACS of the institution and without requiring the institution to reconfigure their security firewall. By avoiding these complex institutional decisions, the present method also avoids the delays and expenses that have been a significant impediment to providing patients with the kind of information that will tend to reduce unwarranted care.

The invention, in one aspect, is directed to a system and related methods for providing a Virtual Radiology service. This service potentially can bring substantially any radiological digital image data, including other patient medical-related data, to substantially any hand held, laptop, desktop, work station or other suitable computer at any institution. Though data may be accessible throughout an institution, controls may be placed to limit on a “right to see” via implicit or explicit control mechanisms. The service is “Virtual” due because the radiological digital image data accessible on the DICOM LAN and PACS of a first institution is made available to a second institution, without either institution having to open their networks to each other, establish legal or other business relationships and understandings or to become administratively involved with each other. That is, institutions do not require direct security-related trust relationships between institutions and may, if preferred, intermediate the business-related relationships through the Central Facility. According to one embodiment, the system includes one or more intermediary Central Facilities that isolate each institution from, preferably all, others and maintain centralized records of, preferably all, data transfers and security to comply with applicable regulatory laws (such as HIPAA). According to another aspect, the invention includes a method by which an intermediary Central Facility manages the encryption of data and the encryption/decryption keys between institutions involved in the transfer of radiological digital image data. Preferably, the method of the invention supports the speculative transmission of radiological digital image data to institutions. Although, the described illustrative embodiments are oftentimes based upon radiological digital image data, this intended to be exemplary in nature and not to be limiting.

An object of the invention to provide a system that can “virtually” connect the DICOM LAN and PACS of a first institution to the DICOM LAN and PACS of a second institution.

Another object of the invention is to provide a system that includes an intermediary Central Facility that manages the “virtual” connection.

A further object of the invention is to provide a method for security where an intermediary Central Facility manages cryptographic keys such as for encryption, decryption and authentication of the radiological digital image and other patient medical-related data that is transferred between institutions.

An additional object of the invention is to provide a method where an intermediary Central Facility maintains such centralized records of all transfers of radiological digital image data between all institutions as necessary for regulatory compliance of the institutions involved in the transfers of the radiological digital image and other patient medical-related data.

Another object of the invention is to provide a method where the radiological image data can be transferred speculatively between institutions.

A further object of the invention is to ensure recipient of radiological image data and other patient medical-related information is authorized to receive data and to provide for secure separations/walls between various party's data.

Another object of the invention is that the central facility determines recipients based on several factors including trust models, cost to process data, region (including country), priority (e.g., medical emergency), quality of server, time to deliver, favored relationships, etc.

Another object of the invention is that multiple central facilities may be part of the infrastructure for the purposes of redundancy as a fail over mechanism, reliability to provide sufficient throughput and resource allocation, regional segregation to satisfy, for instance, regional regulatory issues, etc.

Another object of the invention is that multiple central facilities may be hierarchical in nature including a tree-like structure with a root or graph-like structure without a root.

Another object of the invention is that information may be pulled by one or more recipients with rights to receive including but not limited to the first requester as being the only one, the lowest cost requestor, or other form of criteria.

Another object of the invention to enable a router, or preferably a Central Facility, to wrap or embed rights management, including watermarks and digital rights management, into documents prior to transfer.

Another object of the invention is that a Central Facility store patient data in which the patient or owner of data may push data to other entities or provide access rights to obtain data at Central Facility or other storage facility.

### BRIEF DESCRIPTION OF THE DRAWINGS

FIG. 1 is a system diagram showing the logical connections between two institutions and a central facility according to an illustrative embodiment of the invention.

FIG. 2 is a system diagram showing a multiplicity of institutions connected to the central facility according to an illustrative embodiment of the invention.

FIG. 3 is a diagram of the logical elements of a system router component according to an illustrative embodiment of the invention.

FIG. 4 is a diagram of the logical elements of a system access interface component according to an illustrative embodiment of the invention.

FIG. 5 is a diagram of the logical elements of the system central facility according to an illustrative embodiment of the invention.

FIG. 6 is a diagram of the logical elements of the router, access interface, and central facility in an operational variation of the invention utilizing CCOW.

FIG. 7 is a table detailing a first method of transfer of data between institutions and the central facility where the data is aggregated by the central facility according to an illustrative embodiment of the invention.

FIG. 8 is a table detailing a second method of transfer of data between institutions and the central facility where the data is streamed by the central facility according to an illustrative embodiment of the invention.

FIG. 9 shows the system connected to a DICOM LAN of an institution while functionally appearing similar to a typical modality connection such as a workstation according to an illustrative embodiment of the invention.

FIG. 10 is a diagram detailing the flow of data, orders, encryption keys, and requests for studies between two routers, the central facility and a workstation, according to an illustrative embodiment of the invention.

FIG. 11 is a diagram of the logical elements included in a transmitted Study according to an illustrative embodiment of the invention.

FIG. 12 is a diagram of the display in a DICOM viewer showing the order form and series thumbnails with an image series selected and displayed above according to an illustrative embodiment of the invention.

FIG. 13 is a diagram of the display in a DICOM viewer showing the order form and series thumbnails with the order form selected and displayed above according to an illustrative embodiment of the invention.

### ILLUSTRATIVE DESCRIPTION

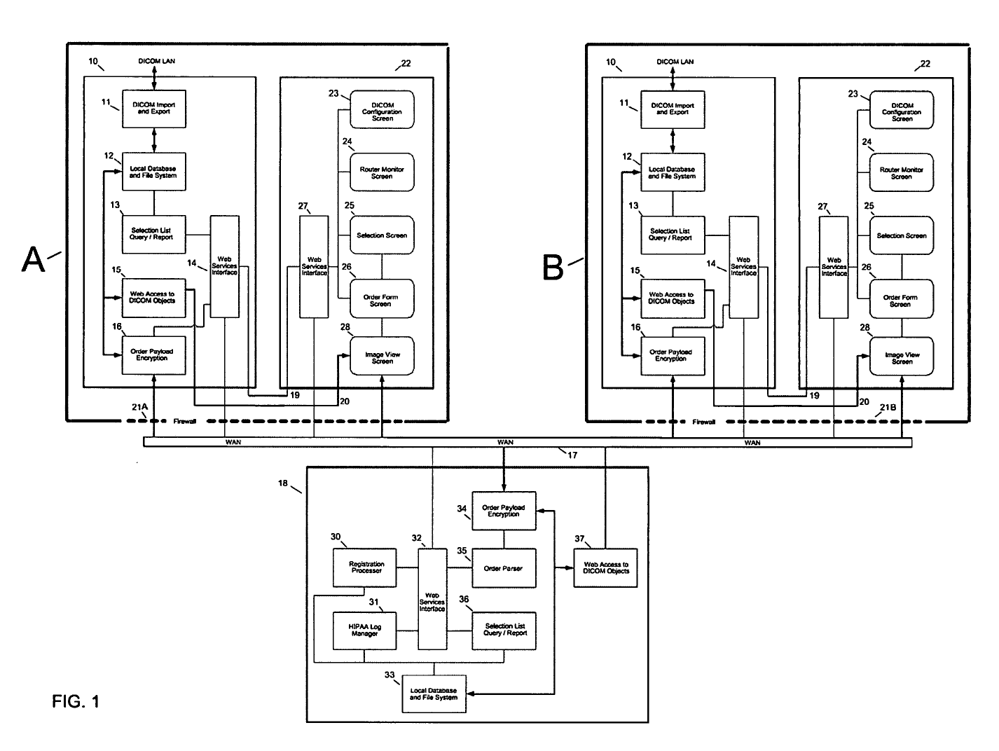

Referring to FIG. 1, in one illustrative embodiment, the invention includes a system and a method for electronically moving DICOM data between institutions A and B under the control of an intermediary Central Facility 18. For simplification of our description and without limitation, we refer to A as the sender and B as the receiver. The suggested implementation of the invention is the existence of a computer on the institutional DICOM LAN that has DICOM Picture Archiving and Communication System (PACS). These systems are generally under the control of one or more User(s) with access privileges. For example, a user would be allowed by the institution to install or to operate a DICOM workstation.

The institutions A and B and Central Facility 18 communicate over a WAN 17, which typically is the Internet but may be any communication network. The elements of the system are comprised of router 10, access interface 22 and intermediary Central Facility 18. We use the term Central Facility in a generic sense and it is not intended to be limiting. It is intended that multiple central facilities may be part of the infrastructure for the purposes of redundancy as a fail-over mechanism to increase reliability, to provide sufficient throughput and resource allocation, and to provide for regional segregation to satisfy, for instance, national regulatory issues, etc. Our description is of a single central facility to simplify the explanation in the embodiment.

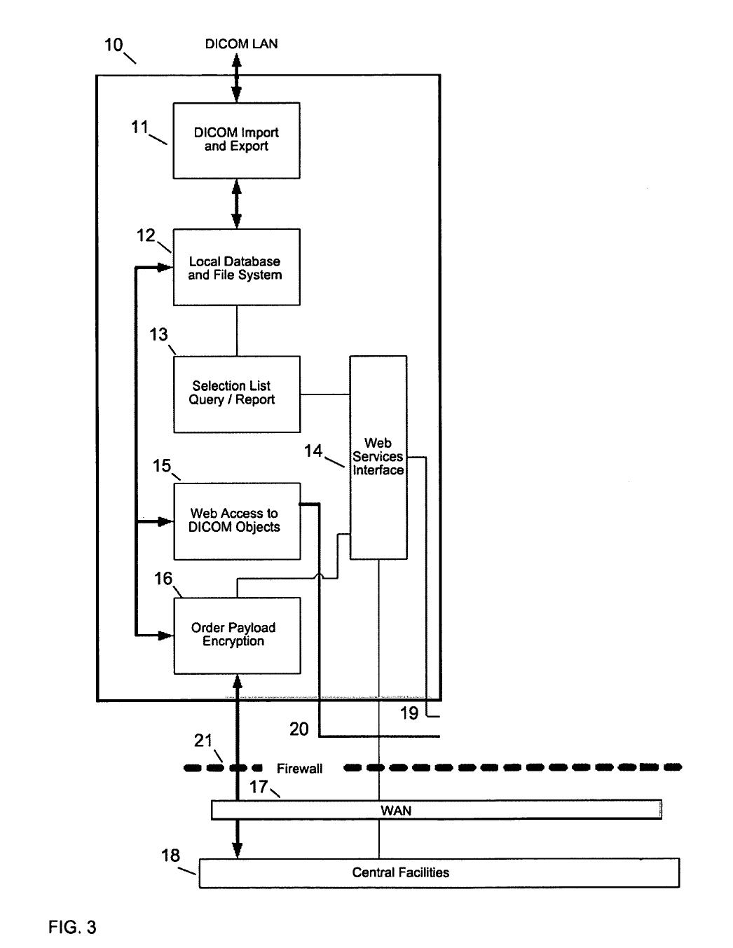

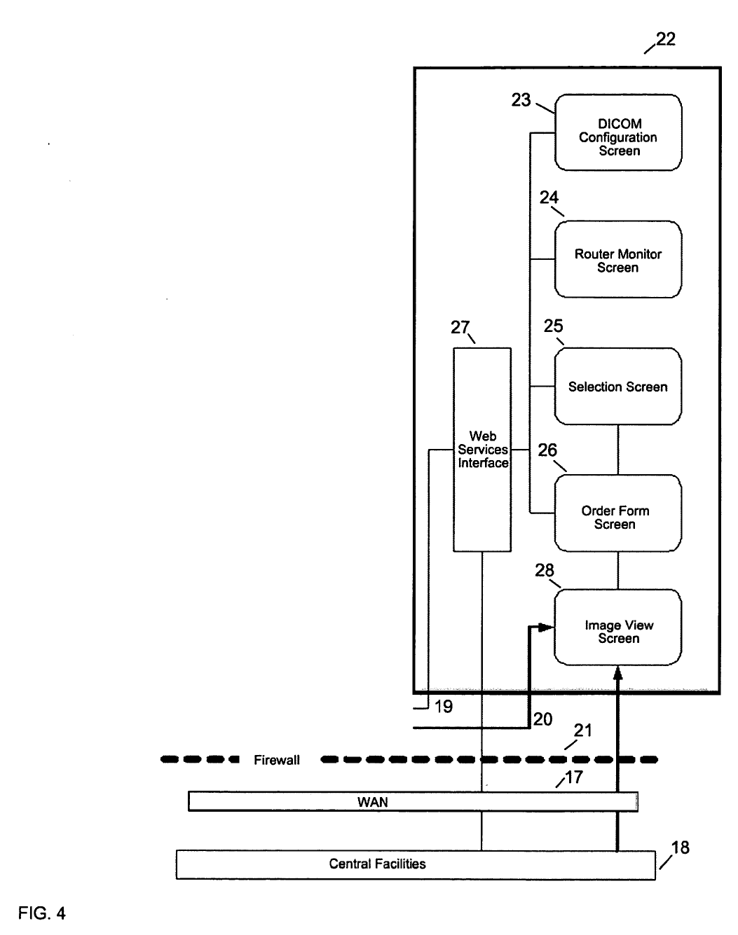

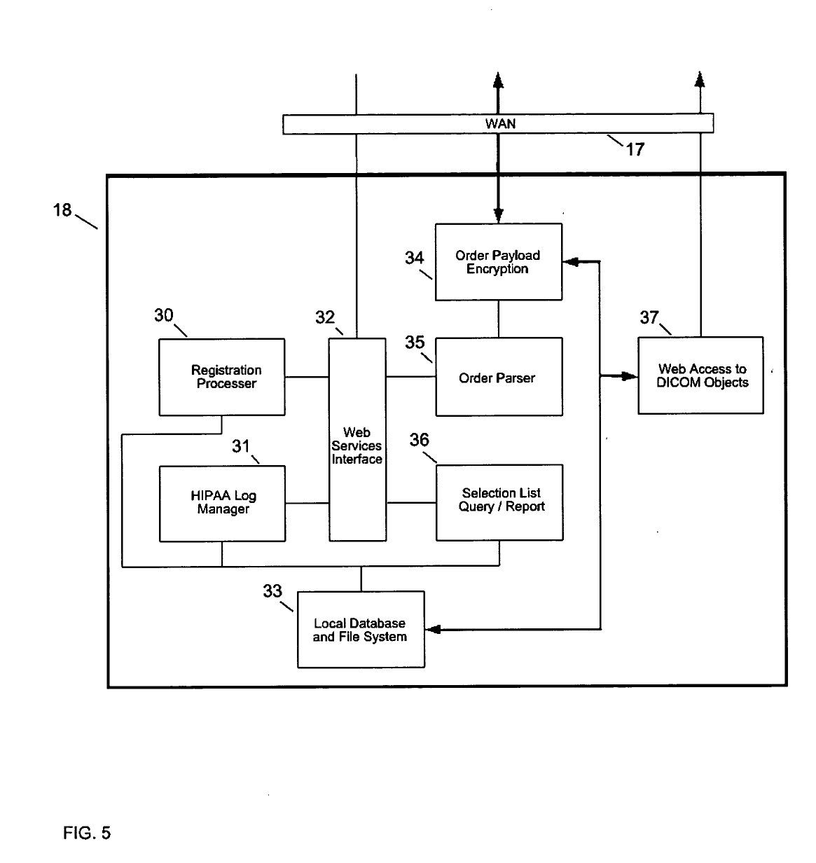

Referring to FIG. 3, FIG. 4 and FIG. 5 a DICOM Configuration Screen 23 configures the Router 10 to join the DICOM network, though automated methods which search and discover the environment may be incorporated. The DICOM Import and Export 11 is used to populate and update a Local Database and File System 12 of imaging studies in accordance to a user's privileges and role relative to the PACS. Though a local database is preferable, it is conceivable that “local database” data would be provided via the network via other devices or network storage devices. The Local Database and File System 12 provides temporary storage of imaging studies and items such as pending orders that might be the subject of a transfer. A Selection List Query/Report 13 responds to parameters entered by the User on Selection Screen 25 with a report that populates a list on the Selection Screen 25 with items from Local Database and File System 12. Alternate embodiments would build a Selection List Query Report 13 by a query to the PACS directly. Web Services Interface 14 and 27 relay messages between the Router 10 and Access Interface 22 using standard protocols over LAN connections 19 and 20. The web interface represents an example of network interconnection and protocol. The Router 10 can be located on a different computer form the Access Interface 22 and multiple Access Interfaces 22 can communicate with multiple Routers 10.

In use the User picks one or more items from the Selection Screen 25. Each item typically represents a DICOM Study. The item(s) selected populate the payload field of an instance of an Order as displayed on the Order Form Screen 26. Information such as the Patient's name, and Referring Physician are derived from the DICOM Study metadata and can be used to populate other fields of the Order Form Screen 26. Furthermore, the Order Form Screen 26 can use the Web Services Interface 27 to fetch additional information form the intermediary Central Facility 18 by using Patient, Physician and other information such Procedure that is available in the DICOM metadata.

An Image View Screen 28 may be available to the User for quality control purposes during the Order creation process. A Web access to DICOM Objects (WADO) 15 module supports the Image View Screen 28. Alternate embodiments would have DICOM access to the Router 10 by a Diagnostic or 3D Workstation or could access images directly from the Local Database and File System 12.

Finalization of the Order, as communicated via the Web Services Interface 14, triggers the Order payload encryption 16 to package the payload and Order information for transport over the WAN to the intermediary Central Facility 18. In alternate embodiments, transport of Order and Payload are subject to various optimizations such as the encryption and speculative streaming of DICOM images as they come in or the use of image compression. The intent of 16 is to provide privacy mechanism over to 10. Hence, private lines, SSL and other methods known in the art of information security may be applicable. A wireless WAN module or other means in the Router 10 can provide an alternative way to bypass the institutional firewall and preferably have the Router serve that firewall function in order not to compromise the institution's network. In cases where the Order does not require the Central Facility to store the Payload, direct Router to Router Transfers are possible, with the Central Facility performing all the coordination, auditing and payment accounting, but not transfer of the actual Payload data blocks.

The intermediary Central Facility 18 provides temporary buffering and routing for studies of the way to Routers 10 at other facilities. In some cases, 18 may provide archiving as a secondary function. Orders are typically decrypted and re-encrypted with keys that are specific to the destination Router 10. We can represent in FIG. 1 source router 10 in Box A and Destination router 10 in Box B. Payload metadata may be examined to assist in routing if the Order Form itself does not have sufficient information. Payload images and reports are made available directly to Web browsers using a WADO module 37 at the intermediary Central Facility 18. The intermediary Central facility 18 keeps a HIPAA log of transfers that is accessible to the Patient and to other authorized Users and further provides long term archiving. The intermediary Central Facility 18 allows the speculative capture of images accompanied by incomplete or poorly specified Order Forms. Manual intervention can be used to update and finalize an Order. The intermediary Central Facility 18 is designed in a way that is compatible with transport and storage of payloads that are encrypted with keys that are not available to the intermediary Central Facility 18. The HIPAA log contains information that can document privacy and security breaches including a time/date stamp, a tracking number or other link to transaction details and a record of the parties to the transaction such as the Operator of the sending device, the Recipient of the PHI and the Authority that validated their credentials. Other non-HIPAA logging information, such as, without limitation, payment information, Quality of Service information, and other forms of reporting, may be included. Although logs, including security logs, are common, logs which are controlled by an institution (e.g.: a hospital) or the vendor to an institution (e.g.: a PACS vendor) are not under the control of a patient or a physician in the sense of the present invention. The Central Facility we describe is novel, at least because, it serves the legal and practical requirement for logs (e.g. the HIPAA Log) without the permission or control of the institutions that manage the network and viewing technology being used by an individual physician or patient.

Referring to FIG. 1 and FIG. 5, the intermediary Central Facility 18 services requests that come in through, preferably, a Web Services Interface 32 from a typical Web browser and Web Access to DICOM Objects 37 and via Order Forms that travel with DICOM payloads. The Registration processor 30 is used to create and update a User or Institution profile in the Local Database and File System 33. The Registration Processor 30 can provide information about a User (Patient, Physician) or Institution as an Order Form is being filled out to improve the reliability and security of Order processing. The Registration Processor 30 is also able to issue Tracking Numbers to confirm an acceptable Order and as a Pre-requisite to finalizing an Order Form. A finalized Order Form is one that has been confirmed by both the intermediary Central Facility 18 and the User. Intermediary Central Facility 18 confirmation is typically associated with the issuance of a Tracking Number.

User confirmation is typically associated with an electronic signature on the Order Form. A credit card transaction is optionally associated with the finalization of the Order Form and may be processed by the Registration Processor 30 or by a separate charge capture mechanism. A finalized Order Form arrives at the intermediary Central Facility 18 in association with an encrypted payload. The Order Parser 35 interprets visible and hidden fields of the Order Form as storage and routing instructions. If an Order is incomplete or otherwise inadequate, the payload may be sequestered pending additional manual intervention. The Order Parser 35 directs the Order Payload Encryption 34 module to decrypt the payload for storage in the Local Database and File System 33. Alternatively, payloads may be stored without decryption. The Order Parser 34 directs the Order Payload Encryption module 34 to encrypt the payload with a new key associated with the destination Router and User. The Order Payload Encryption module 34 can then forward the payload to the destination Router using protocols appropriate to WAN transport of large objects. A registered User may access Studies and in-process Orders via the Selection List Query/Report 36 accessed through Web Services or directly from a Web Browser. A Study listed in a Selection List Query/Report 36 can be viewed directly from the intermediary Central Facility via the WADO viewer 37. Intermediary Central Facility 18 WAN transport protocols include Web Services over HTTP and HTTPS, direct HTTP (S) interactions with Web Browsers and other protocols that are more appropriate to the transport of Binary Large Objects. It is assumed that most Routers 10 and Access Interfaces 22 will be located behind firewalls 21, 21A, 21B that the intermediary Central Facility 18 has no control over. To cross firewalls 21,21A, 21B with little or no reconfiguration, Routers 10 work with the Intermediary Central Facility 18 in a manner that allows the Routers 10 to initiate transfers either as a result of User actions or automatically using a polling mechanism.

According to one feature, the system is particularly designed and configured to partition the health care specific elements which function in accordance with health care related standards, such as DICOM, from the non health care related components which function in accordance with standards other than health care standards. This partitioning is expressed in the health care related components of the system being associated with the router 10 and non health care components being associated with access interface 22. This design enables generalizable development of the non-health care related components such as security, certificate signing, workflow, etc.

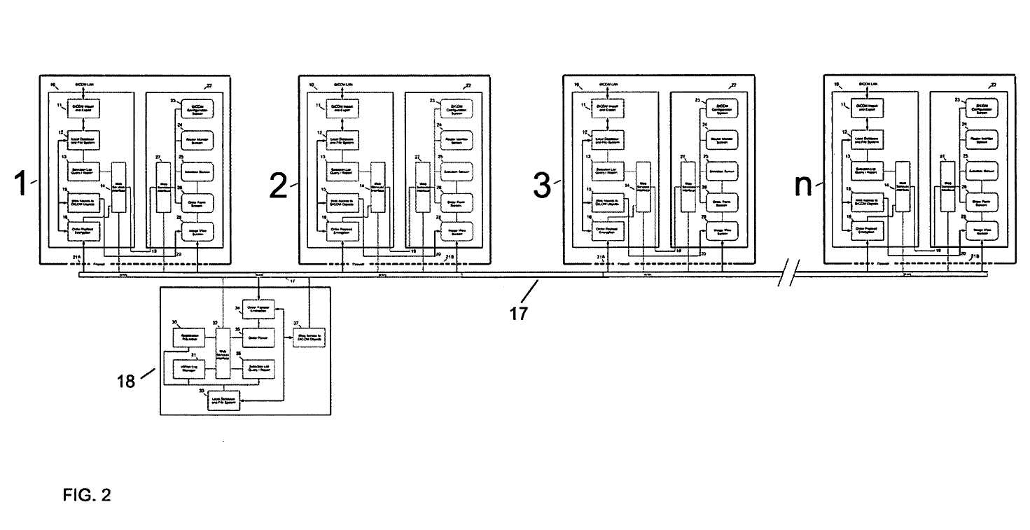

FIG. 2 depicts the connection of any number (1, 2, 3, n) of numerous institutions connecting to the intermediary Central Facility 18. The primary connection of each institution is to the intermediary Central Facility 18. The institutions require no functional direct connection to each other and without the actions and management of the intermediary Central Facility 18 no usable data transfers occurs. In alternate embodiments employing the direct transfer of encrypted payload components between institutions, the transferred components are not useable until a matching Order arrives from the Central Facility 18.

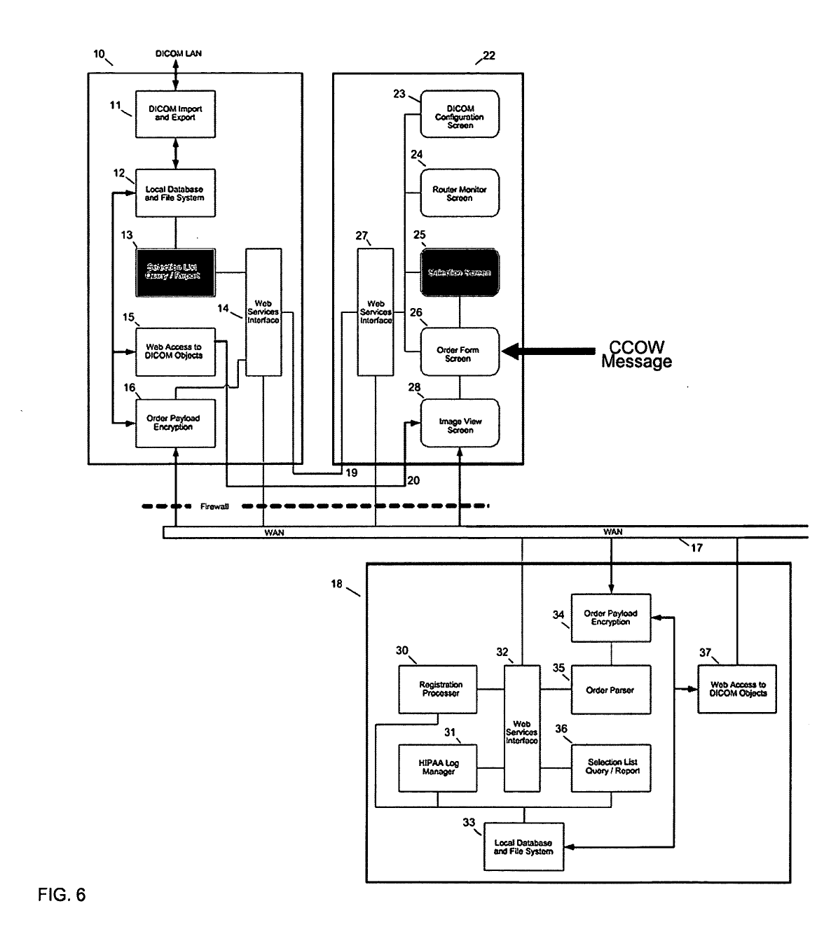

A variation of the utilization of the system is shown in FIG. 6. The acronym CCOW stands for “Clinical Context Object Workgroup”, a reference to the standards committee within the HL7 group that developed the standard. CCOW is a vendor independent standard developed by the HL7 organization to allow clinical applications to share information at the point of care. Using a technique called “context management”; CCOW allows information in separate healthcare applications to be unified so that each individual application is referring to the same patient, encounter or user. CCOW works for both client-server and web-based applications. This means that when a clinician signs onto one application within a CCOW environment, and selects a patient, that same sign-on is simultaneously executed on all other applications within the same environment, and the same patient is selected in all the applications, saving clinician time and improving efficiency. As shown in FIG. 6 in a facility where the Electronic Medical Record (EMR) or PACS supports CCOW, the entire selection process 13 and 25 might be eliminated. A patient or study focus in the EMR will be communicated directly and automatically to the Order Form Screen 26.

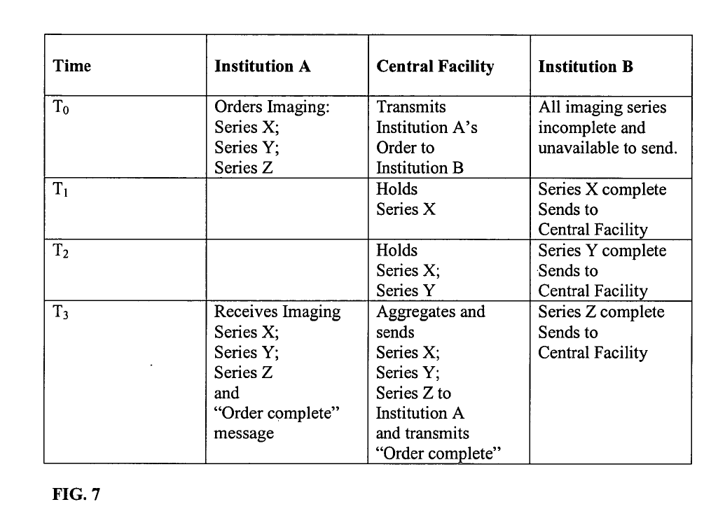

The precise action of the intermediary Central Facility 18 with regard to the actual transfer of radiological digital image data is flexible and can be adjusted to suit the institutions involved. FIG. 7 is a table showing the nature of the data transfer with respect to two institutions and time. When the data is initially requested by institution A it is unavailable at institution B. Subsequently, as the data becomes available, institution B transfers Series X, Series Y, Series Z to the intermediary Central Facility which holds and aggregates the Series X,Y and Z until complete and then transfers the data to institution A.

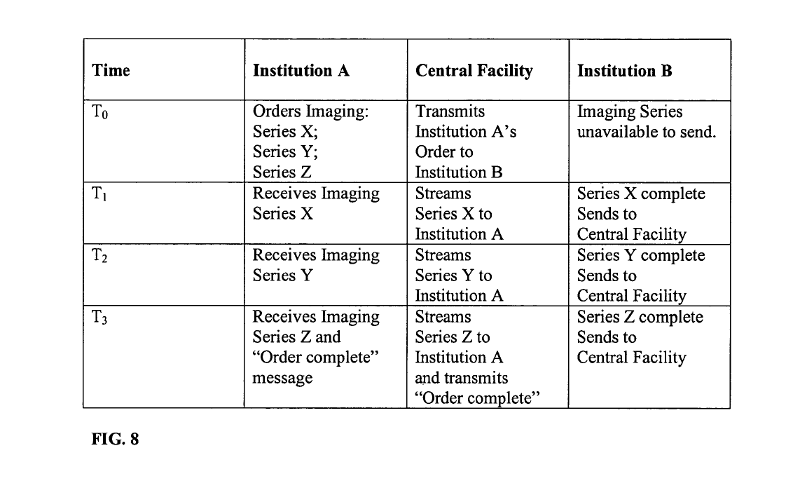

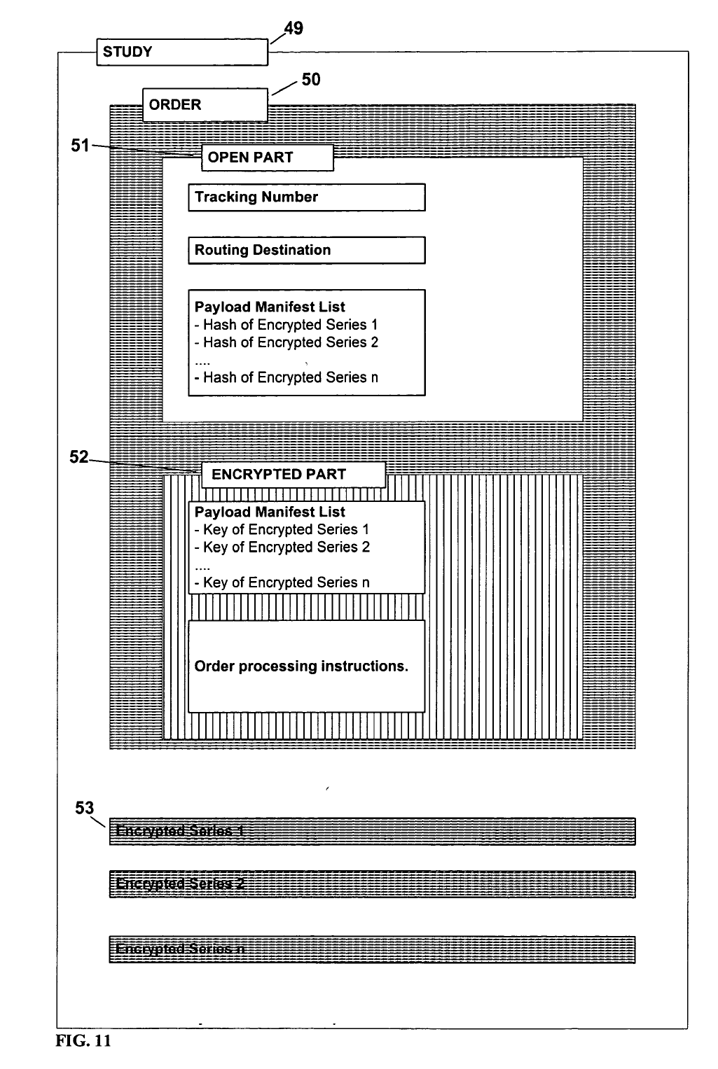

FIG. 8 is a table similar to FIG. 7, which again shows the nature of data transfer with respect to two institutions and time. As in FIG. 7 when the data is initially requested by institution A it is unavailable at institution B. In FIG. 8 rather than hold and aggregate the data the intermediary Central Facility streams the data to institution A contemporaneously as it is received from institution B. An alternate embodiment allows the image data, but not the Order, to bypass the Central Facility 18. The Order 50 (FIG. 11) may travel as a supplemental Series to an original Study or independently when the Encrypted Series bypass the Central Facility 18. In time-sensitive streaming applications, each Series may travel separately as it becomes available and the Order 50 would be updated by the Central Facility 18 as each Series completes.

The intermediary Central Facility manages the data transfer between institutions and could also effect, through the appropriate management of encryption/decryption and authentication keys, the direct transfer of data (aggregated or streamed) from institution B to institution A or the reverse.

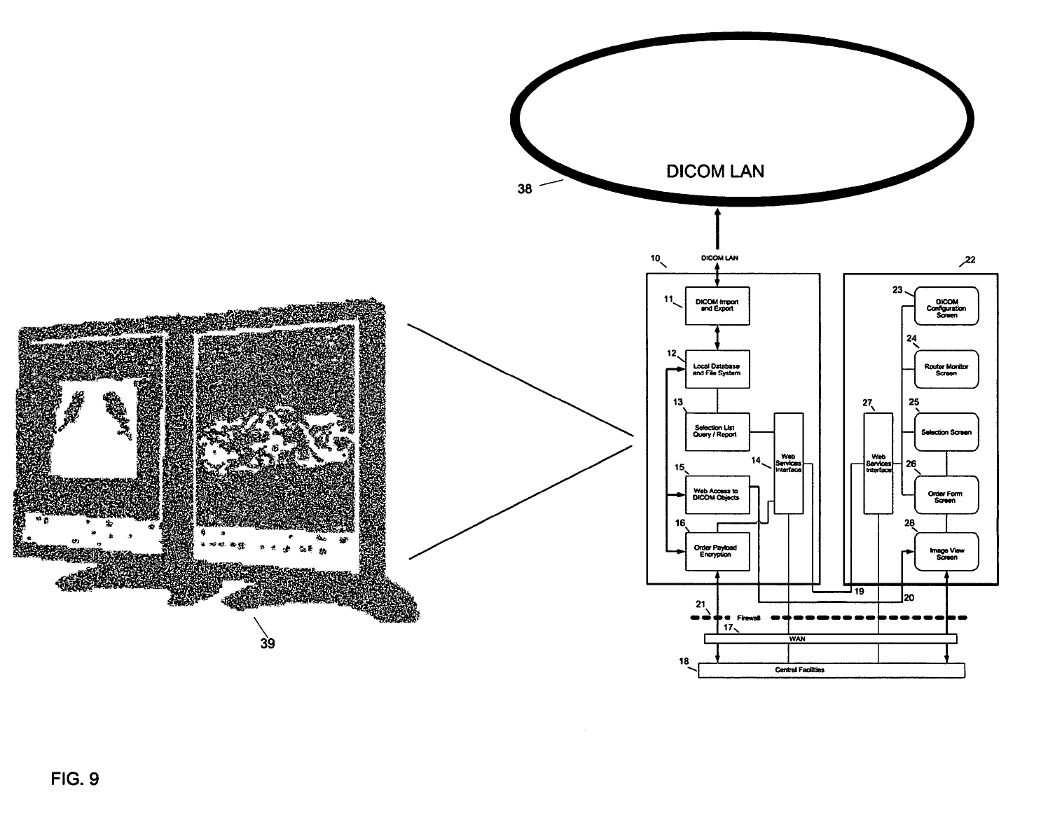

An important aspect of the system is its “Virtual” nature. Institutional networks are complicated by technical, administrative, legal, and regulatory requirements. Opening up these networks directly to each other is a complex problem that is normally not attempted. As shown in FIG. 9 the system 10, 22, 21, 17, 18 of the present invention effects a routine connection to an institution's DICOM LAN 38 in a manner that makes the entire system of the present invention appear as a “Virtual Modality” similar to a workstation 39 or any other modality on the DICOM LAN 38 requiring just routine technical, administrative, legal or regulatory involvement.

Though optional, the system may include one or more of user/institution provisioning (bootstrap) and registry services and related components. As some of the techniques are cryptographic in nature, keys must be provisioned to the appropriate entities. Institutions may have public and/or private keys registered by the central facility or another related component external of the central facility which for simplicity of description we assume exists at the Central Facility. Keys, and similarly, passwords, PINs, token authentication etc. are associated with the institution to provide for private and authentic communication, user authentication and/or user authorization to enable services such as user registration, payment, secure messaging, reporting and account administration by or for the Central Facility.

For simplicity of discussion and without being limiting, a Public Key Infrastructure example is provided, though other methods using techniques known in the art of secure communication, data security and cryptography are possible. For our example, the central facility includes a PKI Certification Authority (CA) though; the Certification authority component may be external of the Central Facility. We refer to the component approving the generation of a certification for a router, similarly a user/patient, as a Registration Agent. Upon contractual agreement between the Registration Agent and a medical institution, a PKI Certificate (e.g., X.509) of the institution based on the institution's public key is generated and published using techniques commonly used and understood in the area of Public Key Infrastructure and cryptography. Furthermore, specific aspects of the contractual agreement may be incorporated in the certificate. This may include key aspects of the contract such as effective period, agreed upon privacy control mechanisms, insurance obligations, points of contacts, regions with appropriate licenses, etc., In essence, an institution may securely communicate with the Central Facility and, moreover, if desired in the system, communicate with others who have been approved. Non-public key and public key without Certification Authority approaches are possible as well.

Not all the information needs to be embedded into a certificate but rather registries such as a database may be used. We will refer to such a database as a Registry. Therefore, either through the Registry or certificates key points of the contract between institutions may be viewed securely.

A bootstrapping process for individuals related to an institution may also be incorporated. Though it is envisioned, but not required, that users associated with an institution do not have separate contracts. It is, however, envisioned that some users are associated with more than one institution. With the PKI example, such a user may have more than one certificate. Certificates for individual users may describe roles of users (e.g., primary physician, Radiologist, System Administrator, Medical Admin, Nurse, etc.), Licenses of the individual (including region), locality, validity period of certificate, Affiliated Institution, relevant contractual provisions, training and education, approved services that using is providing, rights provided by the institution, rights provided by other parties, etc. Many of these may also be incorporated in the institutions certificate.

Though our example is of a certification authority it is possible that a registry institution and individuals is kept external of the PKI as well. It may, for instance, be a local registry held at the Central Facility or external of the Central Facility.

In addition to the above information, institution or users may place in a registry (or certificates) additional information to support in routing of documents including trust models (e.g., types of security controls placed at institutions), cost to process data (e.g., cost to process order), region (including country), priority (e.g., medical emergency), quality of server (e.g., from a rating service), time to deliver (e.g., it takes a specific number of hours to process order), favored relationships, etc. Some of the information may be private and only available to the Central Facility (e.g., favored relationships) which express preferred vendors and some may have limited exposure (e.g., a group a facilities but not all).

When documents (e.g., orders) are routed, the above information may support the routing of the document. It may be used by the sending router to do a direct routing to the recipient, which may bypass the Central Facility, or may be routed to Central Facility whereupon the Central Facility make determination of recipient.

It should be noted that our examples are generally demonstrating the Push model of data transfer wherein Data is pushed to the recipient. However, a pull model is also possible. That is, data (e.g., orders) are sent to from sending router to the Central Facility where they are stored. Recipient routers poll for data which the Central Facility provides using some determination mechanism, including but not limited to the first requester as being the only one, the lowest cost requester, and/or other form of criteria (e.g., licenses, region processing will be performed in, favored relationships with sending institutions).

Furthermore, patient or owners of patient data may require a means to directly enter data or control who may receive the data. (By owner of patient data we mean someone who has a right to read and transfer a patient's data). Hence data may be stored at the Central Facility, or other facility, on a long-term basis. In such a case, the user may request that data is routed to some institution(s) or entities at a time much later than when it was received by the central facility. The routing may be a push (i.e., sent directly to recipient) or pull (e.g., recipient is notified but must extract data). Patient or owner of data may place restrictions on who may receive data or specify criteria on who may receive information.

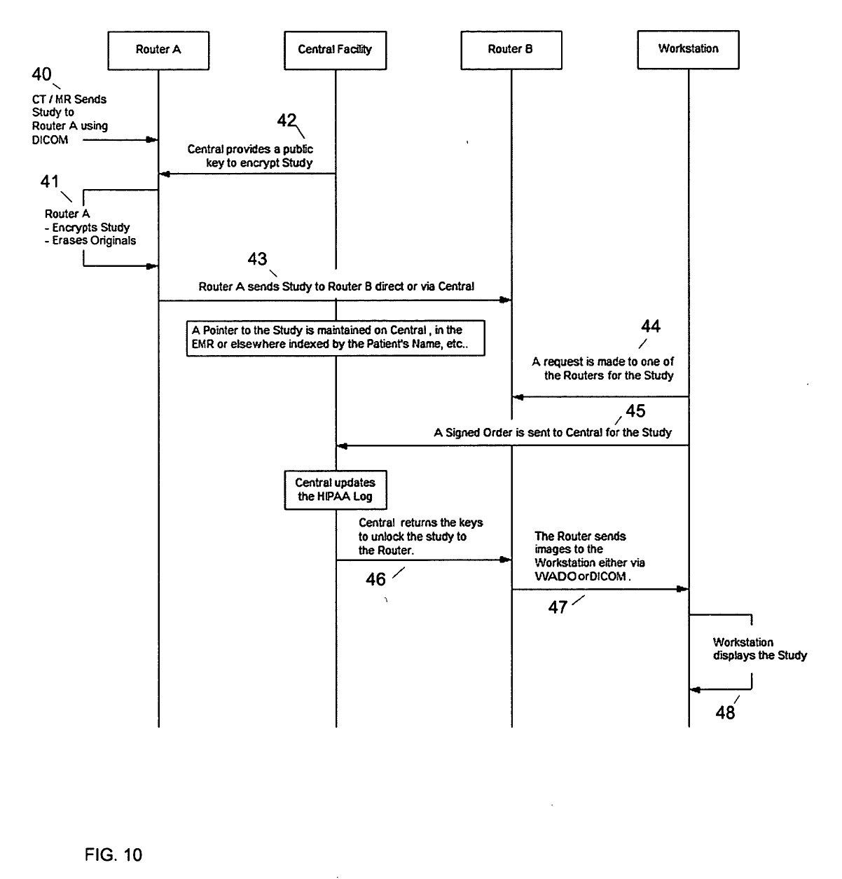

FIG. 10 generally depicts the method of the invention. Router A refers to the part of the system that is behind the firewall in institution A and Router B refers to the part of the system that is behind the firewall in institution B. The Workstation can be anywhere in the system. Starting at 40 a CT/MR etc. sends a Study to Router A using DICOM. At 41 Router A encrypts the Study with a public key of the Central Facility provided at 42 by the Central Facility. Router A then sends 43 the Study to either the Central Facility or Router B. At 44 and 45 a request is made to Router B for the Study and a signed Order is sent to the Central Facility for the Study. The Central Facility at 46 updates the HIPAA log and returns the random keys which are described in the paragraph below to Router B to unlock the Study. Router B sends 47 the Study to the Workstation via either WADO or DICOM. At 48 the Workstation displays the Study. Public key encryption is the preferred method; however, other methods known in the art of secure transmission are applicable.

Upon routing either at the router or, preferably at the Central Facility, rights controls may be wrapped or embedded onto the patient information. That is, Digital Rights management techniques incorporating rights protection of digital content as is known in the art of Computer Security, Data Security and Cryptography may be placed to provide pro-active restriction on who can view the data as well as logging of who has accessed information. Oftentimes digital rights management techniques require a wrapper around the information, which the recipient must “unwrap”. This “unwrapping” process may be done at the recipient router though it leaves the document exposed between the router and final end destination. However, the final point of destination may not be able to handle “wrapped” data and therefore unwrapping at the destination router has many benefits.

Moreover, watermarks which embed information into documents and images may be incorporated. Watermarks provide re-active controls in which each image or document is “serialized” and therefore can be audited. Watermarks are known in the art of Cryptography and Digital Rights Management and have been used to protect music and other media.

The techniques described in this embodiment provide several mechanisms for Discretionary Access Control, which may be used on their own or in combination. Rights management is one technique, encryption and routing of data to only appropriate destination routers, specification of requirements to route to destination address, access rights embedded in patient information internally in the document or externally of the document(s) (e.g., in the order), access controls at the destination router, etc.

As part of the method, the intermediary Central Facility 18 manages encryption which is done primarily by the routers 10. Referring to FIG. 11, each Series 53 is encrypted with its own random Key. The Key will travel with the Order 50. Each Series 53 has a Hash calculated prior to encryption at the origin that validates its contents. In addition, calculating a second Hash of the encrypted Series 53 enables validation of integrity during intermediate transfers without compromising security because the second Hash can be recalculated at each intermediate point. Calculations of the Hash are facilitated by the use of standard algorithms such as SHA-1. Another approach is to use keyed and un-keyed authentication such as Message Authentication Codes, digital signatures, Message Integrity Checks and other data authentication methods known in the art of cryptography and data security. Here in this embodiment without being limiting, we use un-keyed hashing.

Referring to FIG. 10 and FIG. 11. The Order 50 is, preferably, an XML document, which has a Closed or Encrypted part 52 and an Open part 51. The Open part 51 lists one Hash for each Series 53 in the Payload. This makes it possible to validate or discard duplicate Series at anytime. The Closed or Encrypted part 52 lists one Key for each Series 53. The encrypted part of the Order 50 is always encrypted with the Public key of the destination. When the Order 50 is traveling from Router A to the Central Facility, the Order is encrypted with the Central Facility public key. Where the Order 50 is traveling from the Central Facility 18 to Router B, the Order is encrypted with the public key of Router B. If the Order 50 is considered as a supplemental Series in the payload, then the original Series need not be encrypted with PKI but can use the more efficient symmetric key algorithms and the Central Facility 18 doesn't have to re-encrypt the original Series. The order, study, or encrypted series, individual or in combination, may also be authenticated using techniques such as digital signatures or message authentication codes which are known in the art of data security and cryptography. Furthermore, Public key (asymmetric) encryption is exemplary and symmetric key encryption may be used throughout. Key management can be performed through various techniques known in the art such as the use of Kerberos. When asymmetric encryption is used, techniques such as enveloping (i.e., public key encrypts a session key and session key is used to encrypt message part) may be used to improve performance.

As part of the method of the invention, the Central Facility decrypts the Order using its Private Key. The Order is modified to remove fields that Router B should not have or the User should not see. The modified Order is re-encrypted with Router B's Public key and sent to Router B. A HIPAA Log entry is made that IDs the User, the original Router A Order and the Router B Order. Router B receives the modified Order and attaches it to the appropriate Series by checking the Hashes in the Open part of the Order. Router B de-crypts the Order using its Private Key and can stream the Series to the Workstation using WADO or send it on the LAN using DICOM.

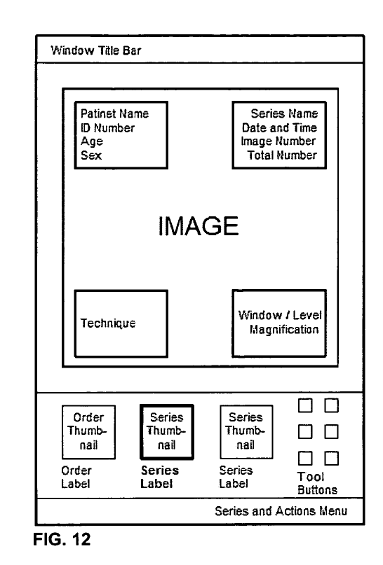

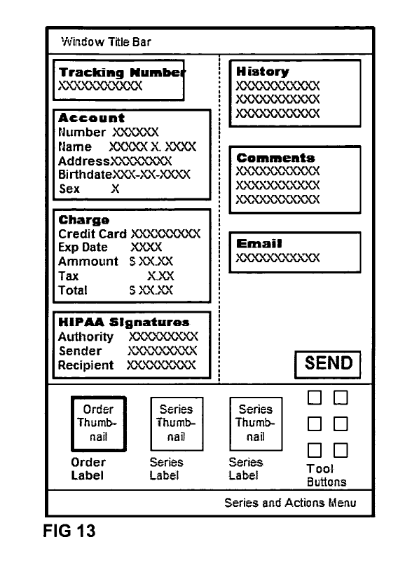

Referring to FIG. 12 and FIG. 13 the Study may consist of various DICOM series and the Order. A feature of this invention is that the Order may be represented utilizing the DICOM standard in the same manner as any image Series. For this reason the Order will automatically be displayed by any device or workstation or display that displays DICOM in the same manner that an image Series is displayed. In FIG. 12 and FIG. 13 this is seen as a selectable thumbnail at the bottom of the display. In FIG. 12 an image Series is selected and the image and image data is displayed in the display area. In FIG. 13, an Order is selected and the Order and Order data is displayed in the display area. The data fields of the Order shown in FIG. 13 can be modified, or managed directly on screen using the routine text annotation tools normally available with many DICOM viewers. This allows Order management to be preformed within the DICOM viewing environment and therefore the user does not have to resort to the invocation of other information management systems to utilize the present invention outside of routine DICOM image viewing systems.

The Order Form is depicted as an additional Series in a typical medical records viewer. Depending on how the Viewer is implemented and configured, this added series might be treated as a component of the diagnostic test rather than as a separate information management system. This approach can selectively bypass and replace institutional controls such as:
1. HIPAA Log—now maintained centrally based on HIPAA Signatures block
2. Patient Medical Record Archive—now collected by Account
3. Technical Support—now accessed by Tracking Number and calls to central facility
4. Intelligent routing and bidding for work based on fields such as History that do not disclose Protected Health Information (PHI).
5. Automatic Routing to destinations outside the institution as shown by the Copy To field.
6. Charge capture independent of the institution including the use of credit cards

Viewers designed or modified according to the present invention can add and present an Order to a typical diagnostic study and can manipulate that Order to control the parts of the Study that contain PHI. In some embodiments, the Order may be routed and communicated along with the study using standard protocols such as DICOM. In some embodiments, the destination of a Study transfer may be forced send the Order series (alone or with the image series) to a central facility for processing before it can access PHI. This enables routing of the study through insecure intermediate caches while ensuring the accuracy of the centrally maintained HIPAA Log.

The linkage of the Order to a Study as preserved in the Central Facility's HIPAA Log is a new enabler for physicians and patients to interact as individuals across institutional boundaries. Examples of typical processing actions that are the point of this interaction are a radiologist's dictated interpretation and a laboratory's computer assisted diagnostic (CAD) measurement of a vascular implant's position. The (CAD) processing protocol and system is typically installed on a workstation or a server. The combination of processing protocol and system and trained user or administrator form the principals of regulatory control for safety and effectiveness (e.g.: FDA 510[k]).

The present invention can be readily used to promote the safety and effectiveness of medical image processing by linking information about the processing actions into the Order and the HIPAA Log along with the privacy-related information.

Examples of the registration of processing actions include preserving (as part of or linked to the HIPAA Log) the model and serial number of a medical device used to process the images in a study. Another example is the actual transport and storage of the information processing system as another series in the Study that is also under the control of the Order and the Central Facility.

Collections of users and services (e.g.: mutual trust groups, bootstrap trust relationships, trademarked service groups and franchises, database mining of both patient identifiable and anonymous information) can be designed on top of the systems and methods described herein. These groupings, either quasi-static or dynamically determined at the time of use, should not be regarded as a compromise of the potential for voluntary participation and control by individual patients and physicians through the systems and methods described above.

It will thus be seen that the objects set forth above, among those made apparent from the preceding description, are efficiently attained and, since certain changes may be made in the above construction without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

We claim:

1. A system for virtual radiology comprising:
a first router,
a first access interface,
at least a second or more router or routers,
at least a second or more access interface or access interfaces, and
a central facility which manages the transfer of data between the two or more routers over a WAN.

2. A system for virtual radiology as claimed in claim 1 where the first router is connected to the DICOM LAN behind the firewall of a first institution and a WAN and a second router is connected to the DICOM LAN behind the firewall of a second institution and a WAN.

3. A system for virtual radiology as claimed in claim 2 where the first router and second router communicate with a central facility, which manages data transfer via a WAN.

4. A system for virtual radiology as claimed in claim 3 where the central facility is not behind the firewall of the first institution and not behind of firewall or firewalls of the second or more institution or institutions.

5. A system for virtual radiology as claimed in claim 4 where the central facility manages a multiplicity of routers behind a multiplicity of firewalls at a multiplicity of institutions.

6. A system for virtual radiology as claimed in claim 5 where the data being transferred is a DICOM series or a multiplicity of DICOM series.

7. A system for virtual radiology as claimed in claim 6 including an XML order document.

8. A system for virtual radiology as claimed in claim 6 where the functionality of the access interface or access interfaces is provided automatically using methods that are associated with IHE or CCOW.

9. A method for virtual radiology comprising the steps of:
a) receiving an Order for a Study or an Order for a Study and the Ordered Study or a Study containing the Order for the Study as a Series at a Central Facility from a router on the network of a first institution;
b) processing any of the Order for a Study or the Study containing the Order as a Series at the Central Facility;
c) sending the processed Order for a Study or the processed Order for a Study and the Ordered Study or a Study containing the processed Order for the Study as a Series from the Central Facility to a router on the network of a second institution.

10. A method for virtual radiology comprising the steps of:
a) speculatively sending an Order for a Study or an Order for a Study and the Ordered Study or a Study containing the Order for the Study as a Series from a router behind the firewall of a first institution to a router behind the firewall of a second institution;
b) sending the Order, or the Study containing the Order as a Series from either the first institution or second institution to the Central Facility where it is processed by the Central Facility;
c) sending information and or instructions and or a processing protocol or protocols and or other data from the Central Facility to a router behind the firewall of the second institution that enables the second institution to view and or process and or otherwise manage the received Study.

11. A method for virtual radiology comprising the steps of:
a) receiving an Order for a Study or an Order for a Study and the Ordered Study or a Study containing the Order for the Study as a Series at a Central Facility from a router behind the firewall of a first institution;
b) processing any of the Order, the Study, or the Study containing the Order as a Series at the Central Facility;
c) sending the processed Order for a Study or the processed Order for a Study and the Ordered Study or a Study containing the processed Order for the Study as a Series from the Central Facility to a multiplicity of routers behind the firewalls of a multiplicity of institutions.

12. A method for virtual radiology as claimed in claim 9 and including recording, by the Central Facility, an entry in a HIPAA log detailing the transfer of the Study or Studies from the first institution to the second institution.

13. A method for virtual radiology as claimed in claim 10 and including recording, by the Central Facility, an entry in a HIPAA log detailing the transfer of the Study or Studies from the first institution to the second institution.

14. A method for virtual radiology as claimed in claim 11 and including recording, by the Central Facility, an entry in a HIPAA log detailing the transfer of the Study or Studies from the first institution to a multiplicity of institutions.

15. A method for virtual radiology as claimed in claim 9 and including assigning, by the Central Facility, a tracking number to the order.

16. A method for virtual radiology as claimed in claim 10 and including assigning, by the Central Facility, a tracking number to the order.

17. A method for virtual radiology as claimed in claim 11 and including assigning, by the Central Facility, a tracking number to the order.

18. A system for virtual radiology as claimed in claim 6 where health care specific components functioning in accordance with health care specific standards are partitioned and associated with the router component of the system and the non health care specific components, functioning in accordance with standards other than health care specific standards, are associated with the access interface.

19. A method for virtual radiology as claimed in claim 9 where the Order for a Study is represented utilizing the DICOM standard and is displayed as a DICOM Series so that it is automatically represented and displayed in any DICOM viewer, DICOM workstation, or other DICOM display.

20. A method for virtual radiology as claimed in claim 9 where the Order for the Study is filled out, modified or otherwise managed in a DICOM viewer.

21. A method for virtual radiology as claimed in claim 9 where the processed Order in step (c) includes additional information and or additional instructions and or an additional processing protocol or protocols and or other additional data as a result of being processed by the Central Facility.

22. A method for virtual radiology comprising the steps of:
a) sending a Study from a first institution to a second institution through the management of a Central Facility;
b) altering the Study at the second institution;
c) returning the altered Study to the first institution with additional information, instructions, protocols or data regarding the specific alterations to the Study;
d) automatically detailing in the HIPAA log of the Central Facility the details of the alteration of the Study by the second institution.
